(19) United States
(12) Patent Application Publication
(10) Pub. No.: US 2010/0189323 A1
(43) Pub. Date: Jul. 29, 2010

(54) COMPUTER-AIDED DIAGNOSIS APPARATUS AND METHOD FOR CONTROLLING THE SAME

(75) Inventor: Yukio Sakagawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/692,952

(22) Filed: Jan. 25, 2010

(30) Foreign Application Priority Data
Jan. 27, 2009 (JP) 2009-015786

(51) Int. Cl. G06K 9/00

(52) U.S. Cl. 382/128

(57) ABSTRACT

A computer-aided diagnosis apparatus includes a storage unit configured to store a plurality of schema background images and can support a diagnosis to be performed based on at least one of the schema background images. The computer-aided diagnosis apparatus includes an input unit configured to input medical inspection data of an inspection object, an analysis unit configured to analyze the medical inspection data, a selection unit configured to select a schema background image from the plurality of schema background images stored in the storage unit based on an analysis result obtained by the analysis unit, and an output unit configured to output the schema background image selected by the selection unit.

### BACKGROUND OF THE INVENTION

1. Field of the Invention

The present invention relates to a computer-aided diagnosis apparatus that can support a diagnosis to be performed based on a schema background image, and a method for controlling the computer-aided diagnosis apparatus. The present invention further relates to a computer-aided diagnosis system, a program that causes a computer to execute the control method, and a computer-readable storage medium. More specifically, the present invention is applicable to a computer-aided diagnosis apparatus that generates medical documents, such as clinical records (diagnostic records) and image diagnosis reports.

2. Description of the Related Art

Physicians used to work with handwritten paper medical documents before introducing a system for generating electronic data of medical documents (e.g., clinical records and image diagnosis reports). Therefore, the physicians needed to draw, by handwriting, a schema background image (more specifically, an illustration indicating a positional relationship between a human body structure and a diseased portion.)

Medical information systems that have been recently developed, such as a hospital information system (HIS) and a picture archiving communication system (PACS), can advance conversion of medical documents into electronic data. More specifically, a computer-aided diagnosis apparatus has been introduced to enable physicians to electronically generate and display medical documents (i.e., the clinical records and image diagnosis reports), which were conventionally generated by handwriting, using an information device. Further, the computer-aided diagnosis apparatus which can communicate with other medical information systems is introduced.

When a medical document is electronically generated, physicians can relatively easily input character strings, for example, via a keyboard. Further, to draw a shape of an arbitrary portion or region, physicians can manipulate an input device (e.g., a mouse or a tablet). A locus drawn with the input device can be input as line drawing information. However, a human body structure to be included in a schema background image has a complicated shape. Therefore, the above-described drawing method using the mouse or the tablet is not useful to simplify the drawing operation to be performed by the physicians.

According to a conventional technique discussed in Japanese Patent Application Laid-Open No. 63-240832, image processing can be performed on a chest X-ray image to obtain a contour line of a lung field portion. The obtained contour line can be used to simplify the operation for generating a schema background image.

Further, according to a conventional technique discussed in Japanese Patent Application Laid-Open No. 2006-318154, numerous templates of schema background images (hereinafter, referred to as “basic schema background image”) are stored beforehand in an apparatus to enable physicians to select an appropriate basic schema background image. According to this technique, after a basic schema background image is selected, physicians can easily generate a desired schema background image by adding a simple illustration that indicates a diseased portion on the selected basic schema background image.

Further, according to a conventional technique discussed in Japanese Patent Application Laid-Open No. 11-312202, various schema background images are stored beforehand in an apparatus to enable physicians to input a name of a human body region to display a schema background image corresponding to the input region name. According to this technique, physicians can easily attach a desired schema background image to a medical document without performing an operation for selecting an appropriate one from numerous schema background images.

Further, as a technique relating to the present invention, the Digital Imaging and Communications in Medicine (DICOM) standard is known as a representative standardized communication protocol dedicated to medical image data. The DICOM standard allows a plurality of image diagnosis apparatuses, medical information servers, and medical information viewers to communicate with each other, even if they are manufactured by different manufactures.

The DICOM standard finely determines contents and data structures of medical information (e.g., image information and patient information), sequences in medical information communications, i.e., sequences for requiring services relating to the storage, reading out, print, and inquiry of images, and interfaces. The DICOM standard can be regarded as an international standard in the present medical image field. For example, a technique discussed in the following Japanese Patent Application Laid-Open No. 2000-287013 relates to an image communication method and a relevant apparatus that are conformable to the DICOM standard.

Further, as a technique relating to the present invention, a research and development is conventionally performed for segmentation and recognition of internal organs captured in medical images. The medical images include various types of images, such as simple X-ray images (roentgen images), X-ray computed tomography (CT) images, and magnetic resonance imaging (MRI) images. The medical images further include, as another types of images, positron emission tomography (PET) images, single photon emission computed tomography (SPECT) images, and ultrasonic images.

However, according to the technique discussed in Japanese Patent Application Laid-Open No. 63-240832, a contour line of an unnecessary region other than a target region may be drawn in the operation for calculating contour lines of an image. Further, if the image contains a noise, a contour of the target region may be partly lost or excessively added.

Further, according to the technique discussed in Japanese Patent Application Laid-Open No. 2006-318154, a user can easily select a suitable schema background image in a state where the numerous schema background images are stored hierarchically.

However, according to the technique discussed in Japanese Patent Application Laid-Open No. 2006-318154, if a large number of schema background images are stored, physicians are forced to perform a complicated operation to select the suitable schema background image.

Further, according to the technique discussed in Japanese Patent Application Laid-Open No. 11-312202, physicians are required to precisely and correctly input the name of each region although they are not required to perform the operation for selecting an appropriate schema background image.

In short, according to the above-described conventional techniques, when a medical document is generated, it is difficult to efficiently select a suitable schema background image from a plurality of schema background images.

### SUMMARY OF THE INVENTION

Exemplary embodiments of the present invention are directed to a technique capable of efficiently selecting a suitable schema background image from a plurality of schema background images when a medical document is generated.

According to an aspect of the present invention, a computer-aided diagnosis apparatus that includes a storage unit configured to store a plurality of schema background images and can support a diagnosis to be performed based on at least one of the schema background images. The computer-aided diagnosis apparatus includes an input unit configured to input medical inspection data of an inspection object, an analysis unit configured to analyze the medical inspection data, a selection unit configured to select a schema background image from the plurality of schema background images stored in the storage unit based on an analysis result obtained by the analysis unit, and an output unit configured to output the schema background image selected by the selection unit.

According to another aspect of the present invention, a computer-aided diagnosis system includes the above described computer-aided diagnosis apparatus, a medical image database configured to store medical image data that can be used as medical inspection data, and a medical document database configured to store medical document data to which a schema background image can be added. The computer-aided diagnosis apparatus is connected to the medical image database and the medical document database via a network.

According to yet another aspect of the present invention, a method is provided for controlling the above described computer-aided diagnosis apparatus. The method includes inputting medical inspection data of an inspection object, analyzing the medical inspection data, selecting a schema background image from the plurality of schema background images stored in the storage unit based on an obtained analysis result, and outputting the selected schema background image.

According to yet another aspect of the present invention, a program for causing a computer to function as each unit of the above described computer-aided diagnosis apparatus.

According to yet another aspect of the present invention, a computer-readable storage medium stores the above described program.

Further features and aspects of the present invention will become apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view schematically illustrating an example of an overall configuration of a computer-aided diagnosis system according to a first exemplary embodiment of the present invention.

FIG. 2 is a flowchart illustrating an example of a processing procedure of a method for controlling the computer-aided diagnosis apparatus according to the first exemplary embodiment of the present invention.

FIG. 3 is a view schematically illustrating a window displayed on a monitor illustrated in FIG. 1, in which an example of a medical document is displayed.

FIG. 4 is a view schematically illustrating a window displayed on the monitor illustrated in FIG. 1, in which examples of medical images are displayed.

FIG. 5 is a view schematically illustrating an example of medical images to be displayed as schema background image candidates relating to a target image according to the first exemplary embodiment of the present invention.

FIG. 6 is a view schematically illustrating an example of a medical document accompanied with a schema background image, which is displayed in the window of the monitor illustrated in FIG. 1.

FIG. 7 is a flowchart illustrating an example of a detailed processing procedure for target image analysis processing to be performed in step S105 illustrated in FIG. 2.

FIG. 8 is a flowchart illustrating an example of a processing procedure of a method for controlling the computer-aided diagnosis apparatus according to a second exemplary embodiment of the present invention.

FIG. 9 is a view schematically illustrating an example of a schema background image to which abnormality information is added according to the second exemplary embodiment of the present invention.

### DESCRIPTION OF THE EMBODIMENTS

Various exemplary embodiments, features, and aspects of the invention will be described in detail below with reference to the drawings.

The present invention is not limited to illustrated configurations of the exemplary embodiments.

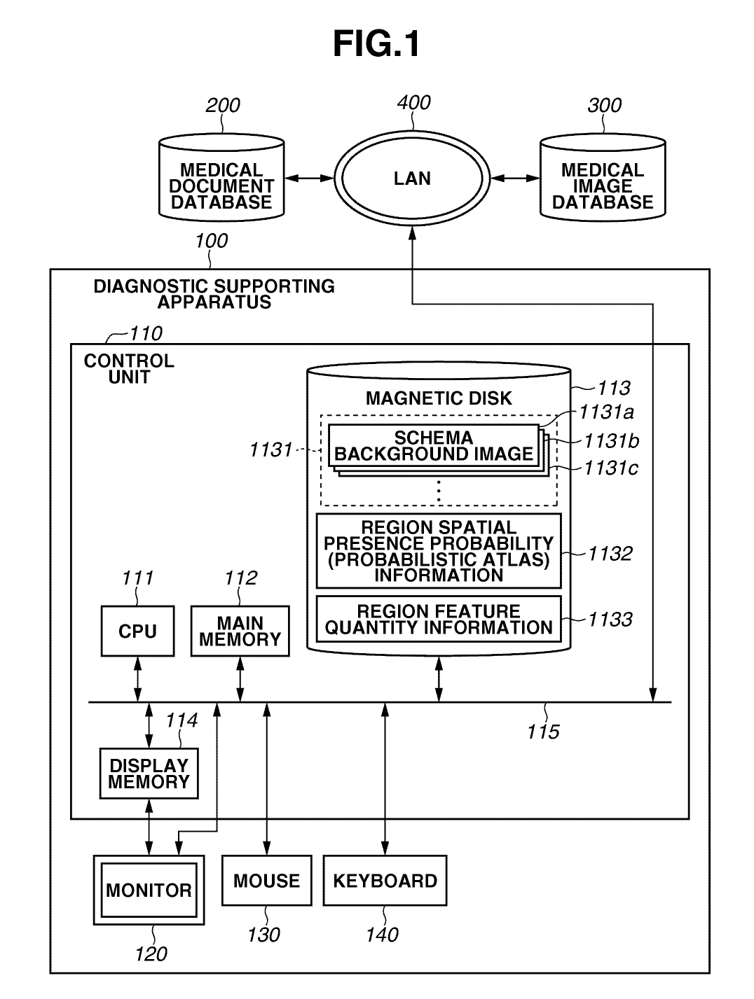

A first exemplary embodiment of the present invention is described below. FIG. 1 is a view schematically illustrating an example of an overall configuration of a computer-aided diagnosis system according to the first exemplary embodiment of the present invention.

As illustrated in FIG. 1, the computer-aided diagnosis system according to the present exemplary embodiment includes a computer-aided diagnosis apparatus 100, a medical document database 200, a medical image database 300, and a local area network (LAN) 400. According to the configuration of the computer-aided diagnosis system illustrated in FIG. 1, the computer-aided diagnosis apparatus 100 is connected, via the LAN 400, to the medical document database 200 and the medical image database 300.

The computer-aided diagnosis apparatus 100 is an apparatus that can support physicians who perform diagnoses using schema background images. The computer-aided diagnosis apparatus 100 includes a control unit 110, a monitor 120, a mouse 130, and a keyboard 140.

The control unit 110 can control various operations to be performed by the computer-aided diagnosis apparatus 100. The control unit 110 includes a central processing unit (CPU) 111, a main memory 112, a magnetic disk 113, a display memory 114, and a bus 115. The CPU 111 can execute software programs stored in the main memory 112, for example, to communicate with the medical document database 200 and the medical image database 300 and to control various operations to be performed by the computer-aided diagnosis apparatus 100.

The CPU 111 can control operations to be performed by each constituent element of the computer-aided diagnosis apparatus 100 and can integrally control the computer-aided diagnosis apparatus 100.

The main memory 112, for example, stores control programs to be executed by the CPU 111 and provides a work area for the CPU 111 when the CPU 111 executes the programs.

The magnetic disk 113, for example, stores an operating system (OS), device drivers for peripheral devices, and various application software programs. The magnetic disk 113 further stores image data relating to a plurality of basic schema background images (i.e., basic schema image data) 1131. In the present exemplary embodiment, the basic schema image data 1131 can be prepared beforehand as model patterns, which are classified into a plurality of levels in preciseness, for example, for each region of the human body structure, and can be registered in association with each region. More specifically, pieces of the basic schema image data 1131a, 1131b, 1131c . . . are stored and registered in the magnetic disk 113. The magnetic disk 113 further stores region spatial presence probability information (probabilistic atlas information) 1132 and region feature quantity information 1133, which are acquired in below described target image analysis processing.

The display memory 114 temporarily stores display data to be displayed on the monitor 120.

The constituent elements of the computer-aided diagnosis apparatus 100 are mutually connected via the bus 115 and can communicate with each other. The computer-aided diagnosis apparatus 100 can communicate, via the bus 115, with external devices accessible via the LAN 400.

The monitor 120 is, for example, a cathode ray tube (CRT) monitor or a liquid crystal monitor. The monitor 120 can display an image based on the display data stored in the display memory 114 according to a control signal supplied from the CPU 111.

The mouse 130 and the keyboard 140 enable a user to perform pointing input and character input operations.

The computer-aided diagnosis apparatus 100 according to the exemplary embodiment can read medical document data (e.g., electronic clinical records and image diagnosis reports) from the medical document database 200 via the LAN 400. The computer-aided diagnosis apparatus 100 can further read various types of medical image data (i.e., medical inspection data) from the medical image database 300 via the LAN 400.

The computer-aided diagnosis apparatus 100 can be connected to an external storage device (e.g., a floppy disk drive (FDD), a hard disk drive (HDD), a compact disk (CD) drive, a digital versatile disk (DVD) drive, a magneto-optical (MO) drive, and a ZIP drive), and can read medical document data and/or medical image data from the external storage device. For example, the medical images include simple X-ray images (roentgen images), X-ray CT images, MRI images, PET images, SPECT images, and ultrasonic images.

The medical document database 200, for example, stores medical document data generated by the computer-aided diagnosis apparatus 100 as well as medical document data received from other apparatus connected via the LAN 400.

The medical image database 300, for example, stores medical image data transmitted from each modality connected via the LAN 400.

The LAN 400 connects the computer-aided diagnosis apparatus 100 to the medical document database 200 and the medical image database 300 so that the computer-aided diagnosis apparatus 100 can communicate therewith.

A processing procedure of a method for controlling the computer-aided diagnosis apparatus 100 according to the first exemplary embodiment is described below.

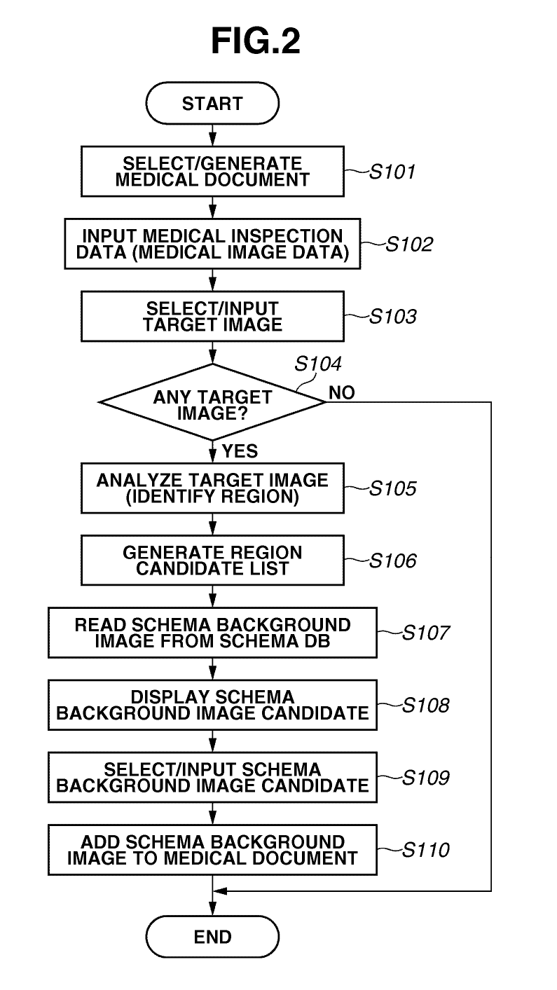

FIG. 2 is a flowchart illustrating an example of a processing procedure of a method for controlling the computer-aided diagnosis apparatus 100 according to the first exemplary embodiment of the present invention. More specifically, the CPU 111 executes the programs stored in the main memory 112 to realize the processing of the flowchart illustrated in FIG. 2.

In the following processing, a physician (i.e., a user) operates the mouse 130 and the keyboard 140 to input various commands (e.g., instructions and commands) into the computer-aided diagnosis apparatus 100. Further, in the following processing, execution situations and results of the programs executed by the CPU 111 are momentarily displayed on the monitor 120. The physician gives necessary instructions while viewing the information displayed on the monitor 120.

First, in step S101 illustrated in FIG. 2, the CPU 111 selects one of the medical document data which has been previously generated according to a command input by the physician and stores the read data in the main memory 112. Alternatively, the CPU 111 can generate new medical document data on the main memory 112. In this manner, the CPU 111 can acquire the medical document data.

Then, the CPU 111 generates display data to be stored in the display memory 114 based on the medical document data acquired in the main memory 112. The CPU 111 displays the generated display data in a window displayed on the monitor 120. Thus, a medical document based on the medical document data can be displayed on the monitor 120.

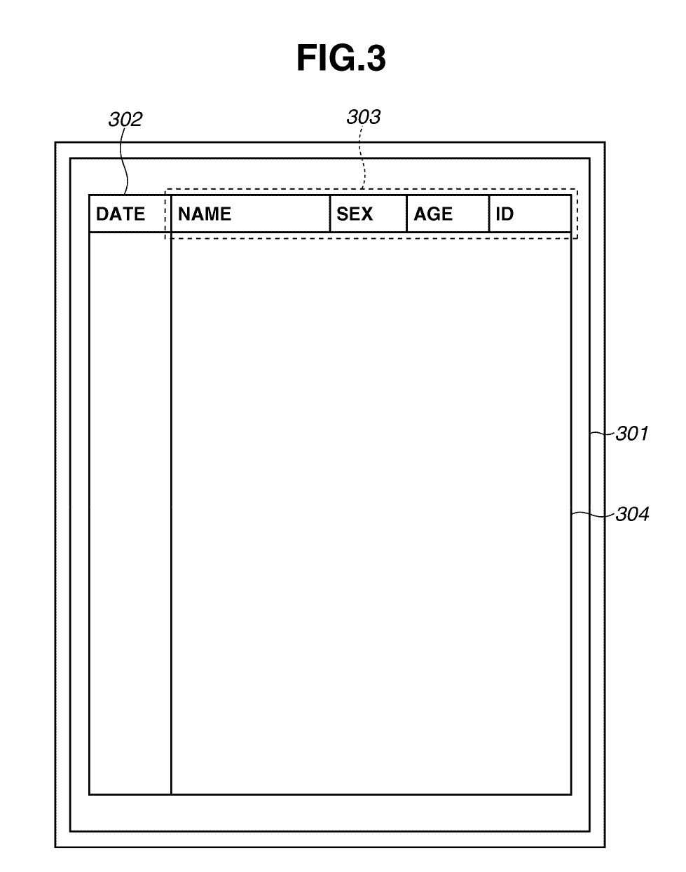

FIG. 3 is a view schematically illustrating a window 301 displayed on the monitor 120 illustrated in FIG. 1, in which an example of a medical document is displayed. The medical document illustrated in FIG. 3 does not include any information that is unnecessary to describe the present exemplary embodiment. The window 301 illustrated in FIG. 3 includes a date field 302 on the left side. The window 301 further includes a patient information field 303 at an upper part thereof, and an observation description field 304 in which physician's can describe observations beneath the patient information field 303. The format for the window 301 is not limited to the one illustrated in FIG. 3.

In the present exemplary embodiment, to realize the medical document data selection processing to be performed in step S101, the CPU 111 communicates with the medical document database 200 via the bus 115 and the LAN 400 and receives desired medical document data from the medical document database 200. Alternatively, the CPU 111 can read desired medical document data from an external storage device (not illustrated) connected to the computer-aided diagnosis apparatus 100. In this case, for example, the physician can input a patient ID to designate the medical document data to be selected. The CPU 111 receives the instructed medical document data from the medical document database 200 (or the external storage device) based on the physician's designation.

Next, in step S102, the CPU 111 inputs medical inspection data of an inspection object in the main memory 112 according to the command input entered by the physician. The CPU 111 generates display data to be stored in the display memory 114 based on the input medical inspection data. The CPU 111 causes the monitor 120 to display an image based on the generated display data. In the present exemplary embodiment, the medical inspection data input in the main memory 112 is inspection object data relating to the basic schema background image (i.e., the basic schema image data 1131) stored beforehand in the magnetic disk 113. In this case, the CPU 111 displays an image (i.e., display data) derived from the medical inspection data in a window different from the window in which an image (i.e., display data) derived from the medical document data is displayed. In the present exemplary embodiment, the medical inspection data is, for example, medical image data.

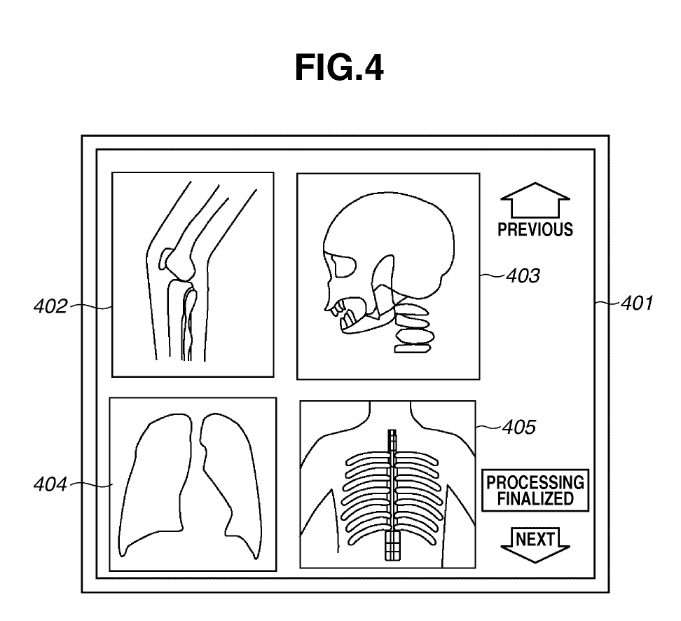

FIG. 4 is a view schematically illustrating a window 401 displayed on the monitor 120 illustrated in FIG. 1, in which examples of medical images are displayed. As illustrated in FIG. 4, four pieces of X-ray images 402, 403, 404, and 405 are displayed, as medical images, in the window 401. The medical images according to the present exemplary embodiment are not limited to the medical images illustrated in FIG. 4. For example, the number of the medical images to be displayed in the window 401 can be changed. If the number of the medical images is increased, the images can be selectively displayed in the window 401 according to a conventional switching method.

In the present exemplary embodiment, to realize the medical inspection data input processing (i.e., medical image data reading processing) to be performed in step S102, the CPU 111 communicates with the medical image database 300 via the bus 115 and the LAN 400 and receives desired medical image data from the medical image database 300. Alternatively, the CPU 111 can read new medical image data from an external storage device connected to the computer-aided diagnosis apparatus 100. In the present exemplary embodiment, the CPU 111 can receive, from the medical image database 300 (or the external storage device), for example, a patient ID of a designated medical document and medical image data associated with an inspection number, which are stored in the main memory 112.

In the present exemplary embodiment, the medical inspection data (i.e., medical image data) read in step S102 can be recorded and supplied according to the DICOM standard. The medical image data reading processing can be executed according to a command input by the physician. Alternatively, when the medical document data is read in step S101, relevant medical image data can be automatically read in association with the read medical document data.

Then, if the physician (i.e., the user) selects and inputs a single target image or a plurality of target images from the medical images displayed on the monitor 120, then in step S103, the CPU 111 selects a target image based on the selection and input. More specifically, the CPU 111 selects one or a plurality of piece(s) of the target image data from the medical image data input in step S102 based on the target image (s) selected and input by the physician (i.e., the user). In this case, for example, to perform the above-described target image selection and input processing, the physician (i.e., the user) can designate (point) a doubtful diseased portion, if it is found in the medical image displayed on the monitor 120, with the mouse 130 and the keyboard 140.

Further, to accurately observe and select each target image, the physician (i.e., the user) may use an enlarged medical image that enlarges a part of the original medical image displayed on the monitor 120. In this case, it is necessary to convert a coordinate point, which is designated (pointed) by the physician (i.e., the user) on a screen that displays the enlarged medical image, into a corresponding coordinate point on the original image. The conversion processing in this case can be performed, for example, based on information relating to the medical image enlargement processing (e.g., enlargement center and enlargement ratio). Further, when the target image selected and input by the physician is a medical image including three-dimensional information, such as an X-ray CT image, the physician (i.e., the user) may observe a sliced image that is displayed as a cross-sectional image which is obtained by cutting the three-dimensional information along a plane. In this case, a three-dimensional position on the original image, which can be indicated by the target image designated by the physician (i.e., the user), can be obtained based on a type and a position of the displayed cross-sectional image.

Moreover, as described above, the target image designated by the user is not limited to only one medical image. The physician (i.e., the user) may designate two or more target images. For example, there is a case where the physician (i.e., the user) may designate a place which is recognized as a primary diseased portion and a place which is suspected as a metastasis from its original site as target images. In this case, the CPU 111 performs processing for successively storing designated plurality of target images and enables the user to input a command instructing to terminate the target image selection and input processing. Further, in the present exemplary embodiment, if the physician (i.e., the user) does not find any abnormality in the medical images while observing the medical images, the physician (i.e., the user) can cause the CPU 111 to terminate the processing of step S103 without performing the target image selection and input processing.

Next, in step S104, the CPU 111 determines whether there is any target image selected in step S103. If it is determined that there is not any target image selected in step S103 (NO in step S104), the CPU 111 terminates the processing of the flowchart illustrated in FIG. 2.

On the other hand, if it is determined that there is at least one target image selected in step S103 (YES in step S104), the processing proceeds to step S105.

When the processing proceeds to step S105, the CPU 111 performs processing for analyzing the target image selected in step S103. More specifically, the CPU 111 performs analysis processing for determining and identifying a human body region of a photographed person included in each target image selected in step S103. In the present exemplary embodiment, the human body region of the photographed person can be a region corresponding to each internal organ, such as “stomach”, “lung”, “liver”, and “heart”, or can be a more detailed region of each internal organ, such as “right lung” or “left ventricle.” Further, the human body region of the photographed person is not limited to the internal organ, and can be a wider region, such as “chest” or “abdomen”.

Accordingly, if the target image input in step S103 is a right lung region, the input target image can be regarded as a part of the lung or can be regarded as a part of the chest. In other words, information indicating a specific region of a medical image identified in step S105 is not limited to only one. As described above, the information indicating the specific region identified in step S105 can be defined using a hierarchical expression including a plurality of regions, such as “upper half body—chest—lung—right lung.” Further, if in step S105 the target image includes a plurality of human body regions to be identified, the CPU 111 identifies information relating to each human body region.

The physician's operations performed on the target images, such as enlargement of an image, designation of a region, and conversion of gradation, are successively stored in the main memory 112, so that the stored operational information can be utilized in image analysis processing. More specifically, the CPU 111 can exclusively perform the image analysis processing only for an enlarged medical image or only for a designated region.

Next, in step S106, the CPU 111 generates a region candidate list based on the human body regions identified in step S105. In the present exemplary embodiment, an order of candidates in the region candidate list is determined considering an extent (i.e., an area size) of each region in the target image selected in step S103. In this case, the area size of each region in the target image can be defined by a number of pixels constituting of each region. Alternatively, size information of pixels in a DICOM header can be used to calculate an actual area size of each human body region. If the medical image data (i.e., the medical inspection data) is volume data (e.g., three-dimensional CT), a region area size in a two-dimensional image and a region volume size in a three-dimensional image can be used to determine the order of candidates in the region candidate list. In the present exemplary embodiment, the CPU 111 generates the region candidate list by prioritizing a region having a large area size in the target image.

In the present exemplary embodiment, the information to be referred to in determining the order of candidates in the region candidate list is not limited to the size of each region. For example, any other information (e.g., ratio of each region in the target image, or percentage of a partly displayed portion relative to the entire region) can be also used. According to the above-described example, the order in the region candidate list is determined with reference to the size of each region. Alternatively, to explicitly display a small region that is difficult to find, it is for example useful to generate a region candidate list in ascending order of region size.

Moreover, as another method for determining the order in the region candidate list, it is useful to refer to information relevant to identification certainty obtained in the human body region identification processing in step S105. Since the human body region identification processing may not be successfully completed, the identification certainty of each region can be taken into consideration in determining the order in the region candidate list.

As described above, the region candidate list can be generated according to human body regions identified in step S105. The CPU 111 generates a schema background image candidate list of basic schema image candidates with reference to the generated region candidate list. More specifically, the CPU 111 performs processing for generating the schema background image candidate list based on the target image (i.e., medical image) analysis result obtained in step S105.

Next, in step S107, the CPU 111 reads basic schema background images of the human body regions included in the region candidate list generated in step S106, from a plurality of basic schema background images stored in the magnetic disk 113 (i.e., the basic schema image data 1131). In the present exemplary embodiment, the CPU 111 processes each read basic schema background image (i.e., the basic schema image data 1131) as a basic schema background image candidate that can be added to the medical document acquired in step S101.

In the present exemplary embodiment, as described above, the magnetic disk 113 stores the plurality of basic schema background images (i.e., the basic schema image data) so as to function as a schema background image storage device (i.e., a schema DB). Further, the magnetic disk 113 stores additional information (e.g., human organs contained in each schema background image, their regions and sizes, and the degree of detail of the structure represented by the schema background image) in association with the corresponding schema background image. Further, recording and management for each schema background image can be performed according to a level expressed by each schema background image, for example, as discussed in Japanese Patent Application Laid-Open No. 2006-318154.

Next, in step S108, the CPU 111 causes the monitor 120 to display (output) another window for the basic schema background image candidates, which are read in step S107, to indicate basic schema background image candidates to the physicians. In this case, the CPU 111 controls the monitor 120 to display the basic schema background image candidates according to the order of the region candidate list determined in step S106. This is effective because the display of a specific basic schema background image, in a case where it is requested by a physician, can be prioritized.

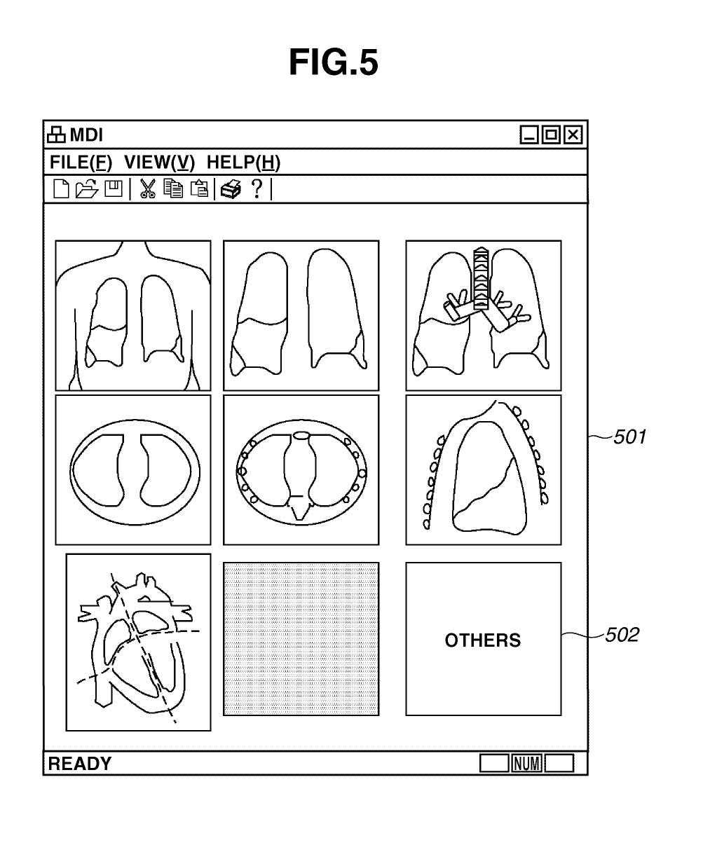

FIG. 5 is a view schematically illustrating an example of medical images to be displayed as schema background image candidates relating to a target image according to the first exemplary embodiment of the present invention. A plurality of images in a window 501 illustrated in FIG. 5 are basic schema background image candidates. If a physician cannot find a suitable basic schema background image in the displayed schema background image candidates, the physician can press an “others” button 502 to request a display (an output) of other images representing schema background images of different human body regions. In response to this requirement, the CPU 111 displays the images of the next schema background image candidates in the window 501.

For example, when the target image includes a plurality of regions (e.g., lung, bronchi, and heart) in a chest of a photographed person, the CPU 111 can display, as schema background image candidates, an image of the entire chest, an image of the lung (as a coronal image), an image of a combination of the lung and the bronchi, an image of the lung (as an axial image), an image of the lung (as a sagittal image), and an image of the heart, as illustrated in FIG. 5. If a photographing direction of each image can be identified in the region identification processing to be performed in step S105, the display of the axial and sagittal images can be performed based on the obtained information.

Next, in step S109, the CPU 111 receives a selection result (i.e., an input indicating a basic schema background image to be displayed) from the physician. The CPU 111 selects the basic schema background image to be added to the medical document, based on the selection input, from the plurality of basic schema background image candidates displayed in step S108. In this case, for example, the physician can select and input a desired basic schema background image with the mouse 130 from the images of the basic schema background image candidates displayed on the monitor 120. In the present exemplary embodiment, for example, an identification number can be allocated to each of the schema background image candidates. In this case, the physician can select and input the identification number of a schema background image to be displayed via the keyboard 140.

Next, in step S110, the CPU 111 adds a basic schema image, which is based on the basic schema background image acquired in step S109, to the medical document read in step S101. In this case, the CPU 111 can perform a display (an output) of the resultant image in superimposition or addition.

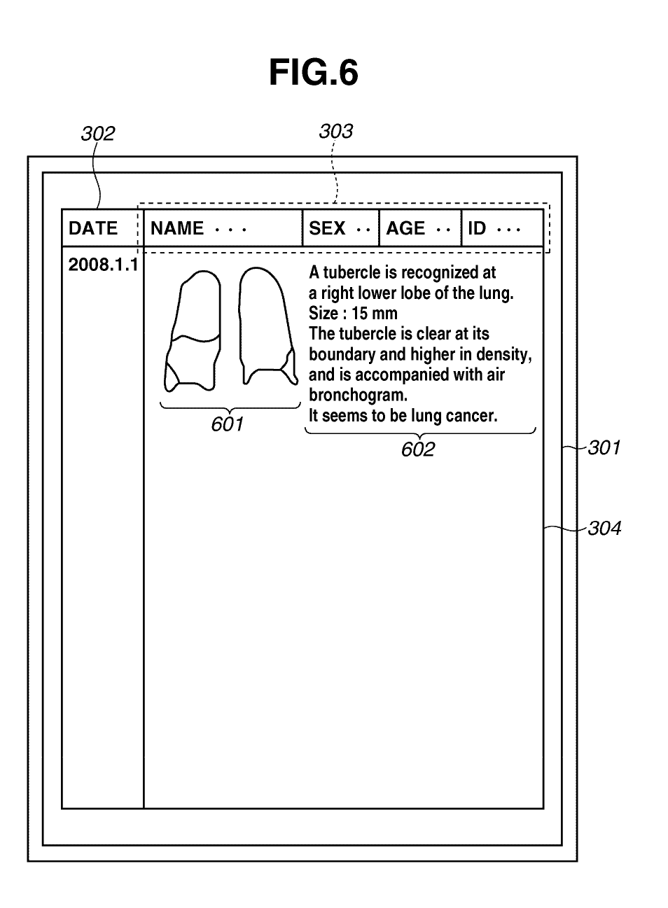

FIG. 6 is a view schematically illustrating an example of a medical document accompanied with a schema background image, which is displayed in the window 301 of the monitor 120 illustrated in FIG. 1.

Compared to the medical document illustrated in FIG. 3, the medical document illustrated in FIG. 6 additionally includes a basic schema image 601 corresponding to the basic schema background image and related observation information 602 in the observation description field 304. Further, compared to the medical document illustrated in FIG. 3, the medical document illustrated in FIG. 6 includes date and time information added to the date field 302 and patient information added to the patient information field 303.

The physician can input the observation information 602 referring to the basic schema image 601, which is relevant to the schema background image displayed in the window 301. Then, the CPU 111 registers the medical document data into the medical document database 200. Then, the CPU 111 terminates the processing of the flowchart illustrated in FIG. 2.

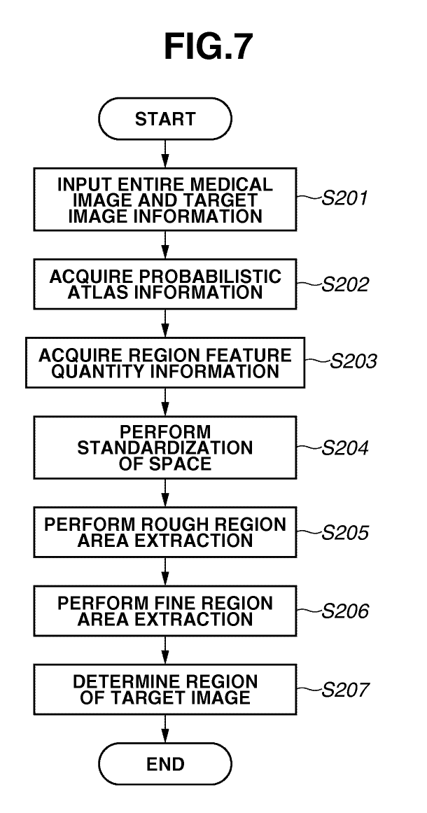

Next, the target image analysis processing to be performed in step S105 illustrated in FIG. 2 is described below. FIG. 7 is a flowchart illustrating an example of a detailed processing procedure for the target image analysis processing to be performed in step S105 illustrated in FIG. 2. More specifically, FIG. 7 illustrates details of the processing for identifying each human body region of the photographed person in the target image analysis processing. In the present exemplary embodiment, the target image to be subjected to the analysis processing is a three-dimensional abdominal X-ray CT image.

When the processing of step S105 illustrated in FIG. 2 is started, first, in step S201 illustrated in FIG. 7, the CPU 111 inputs the entire medical image acquired in step S102 and information relating to the target image to which the physician pays attention.

Next, in step S202, the CPU 111 acquires spatial presence probability information of each abdominal region. The region spatial presence probability information can be acquired by statistically analyzing the region shape, density value distribution, and spatial layout of numerous medical image data. In this case, the abdomen includes various regions, such as right/left kidneys, a spleen, a pancreas, a liver, a gallbladder, and a stomach wall. Then, the CPU 111 stores the acquired region spatial presence probability information, as the region spatial presence probability information 1132, in the magnetic disk 113.

Next, in step S203, the CPU 111 acquires region feature quantity information of each abdominal region. Respective abdominal regions are different from each other in their features (e.g., segmentation parameter, shape feature, and CT value of CT image). Therefore, the CPU 111 can accurately perform the region recognition processing with reference to the individual feature of each region. Then, the CPU 111 stores the acquired region feature quantity information, as region feature quantity information 1133, in the magnetic disk 113.

In the present exemplary embodiment, the region spatial presence probability information and the region feature quantity information are stored in the magnetic disk 113. However, the information can be also stored in the medical image database 300 or in an independent database server via the LAN 400.

Next, in step S204, the CPU 111 performs processing for standardizing the abdominal space. The region spatial presence probability information 1132 is information indicating presence probability relative to a predetermined abdominal index (which may be referred to as a “landmark”). Therefore, it is necessary to determine a positional relationship between the index defined in the region spatial presence probability information and a corresponding index in the target medical image.

In this case, for example, apexes of the right and left kidneys and the lowest point of the spleen are well known indices. Then, based on the determined corresponding index information, the CPU 111 adjusts the three-dimensional X-ray CT image to be subjected to the processing with the space of the region spatial presence probability information. Namely, the CPU 111 can perform the space standardization processing.

After the above-described space standardization processing is completed, in step S205, the CPU 111 performs rough region area extraction for each region based on the region spatial presence probability information 1132. In the present exemplary embodiment, the CPU 111 calculates a post-probability of a region in which a pixel (i.e., pixel(x, y, z) in the case of the three-dimensional image)) of the image is present, with reference to the region spatial presence probability information 1132. Then, the CPU 111 allocates a label of a region which has a highest post-probability value to the pixel. The CPU 111 can use the following formula (1) to calculate the post-probability of each region.

$$p ( l \vert v ) = \frac{p ( v \vert l ) p ( l )}{{\sum }_{l} p ( v \vert l ) p ( l )} \qquad ( 1 )$$

In the formula (1), “1” represents a region label, “v” represents a feature quantity of a pixel(x, y, z), “v” represents a statistically obtained probability of “v” that is present in a certain region “l”, and p(l) represents a pre-probability of the region label “l” that can be obtained from the region spatial presence probability information.

Next, in step S206, the CPU 111 performs fine region area extraction for each region. In the present exemplary embodiment, if the probability of presence of at least part of a region is higher in the processing of step S203, the CPU 111 uses it as an initial area to be used in a segmentation method. For example, the segmentation method employable in the present exemplary embodiment is the LevelSet method and the Snakes method, which are well known in the image processing field. Further, to execute the segmentation method, the CPU 111 can use unique parameters and feature quantities required for respective regions. In the present exemplary embodiment, the CPU 111 performs the fine region area extraction in step S206 according to the segmentation method.

The above-described region segmentation processing is described in more detail, for example, in Shimizu and Sato, “Construction of statistical atlas of abdominal organs and its application to multi-organ segmentation”, Medical Imaging Technology, Vol. 24, No. 3, pp. 153-160, May 2006. An example method for calculating the region identification certainty to determine the order in the region candidate list, which is performed after identifying the region area of the medical image (i.e., the target image), is described below. The present exemplary embodiment uses an average region post-probability of an area that is occupied by the region, as the region identification certainty. For example, the following formula (2) can be used to express the region identification certainty.

$$Region certainty = \frac{{\sum }_{i = 1}^{M} p ( l \vert v )}{M} \qquad ( 2 )$$

In the formula (2), “M” represents the number of pixels that are occupied by the region.

Further, as another method for processing the region identification certainty, information relating to the size of an identified region area may be also used. In this case, average size information for each region can be stored as statistical information other than the region spatial presence probability information. The stored information is usable as the region identification certainty when the size of an identified region is compared with the average size of the region. The present exemplary embodiment is not limited to the above-described method and another appropriate method can be used to calculate the region identification certainty.

Next, in step S207, the CPU 111 identifies a position of the target image to which the physician pays attention in the three-dimensional X-ray CT image (medical image) and determines a region that is present in the target image. For example, the CPU 111 can identify the position of the target image with reference to a slide number of the axial image and spatial position information about the pixel. Then, the CPU 111 terminates the processing of the flowchart illustrated in FIG. 7.

Through the above-described processing of steps S201 to S207 illustrated in FIG. 7, the target image analysis processing of step S105 illustrated in FIG. 2 (i.e., the processing for identifying the region existing in the target image) can be accomplished.

As described above, the first exemplary embodiment analyzes the medical image (i.e., the target image) to which the physician (i.e., the user) pays attention to efficiently select a suitable schema background image from a plurality of schema background images in the generation of a medical document. Accordingly, the physician is no longer required to perform a troublesome work for finding out a schema background image suitable for the diagnosis from a plurality of schema background images in the generation of a medical document. Further, any operation (e.g., enlargement or area designation) performed on the attentional medical image (i.e., the target image) by the physician can be used to efficiently find out a suitable schema background image.

A second exemplary embodiment of the present invention is described below. The second exemplary embodiment is different from the first exemplary embodiment in that an abnormal region (i.e., an abnormal candidate) in each target image is detected by analysis processing and processing for using for abnormality information when a schema background image is selected is added to the processing procedure illustrated in FIG. 2.

An internal configuration of a computer-aided diagnosis apparatus according to the second exemplary embodiment is similar to the above-described internal configuration of the computer-aided diagnosis apparatus 100 according to the first exemplary embodiment illustrated in FIG. 1.

A processing procedure of a method for controlling the computer-aided diagnosis apparatus 100 according to the second exemplary embodiment is described below.

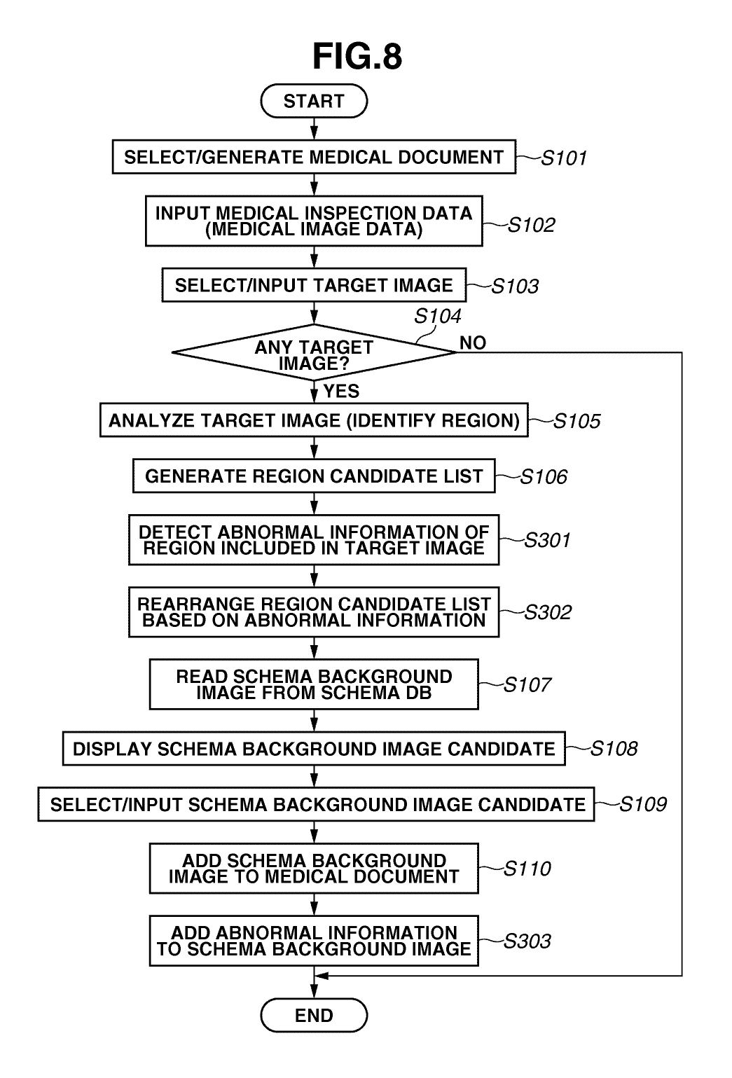

FIG. 8 is a flowchart illustrating an example of the processing procedure of the method for controlling the computer-aided diagnosis apparatus 100 according to the second exemplary embodiment of the present invention. In the present exemplary embodiment, processing similar to the above-described processing of the flowchart illustrated in FIG. 2 is denoted with the same step numbers and detailed descriptions for these steps are not repeated.

First, in the present exemplary embodiment, the CPU 111 executes the processing of the above-described steps S101 to S106 illustrated in FIG. 2.

Next, in step S301, the CPU 111 detects an abnormal region captured in the target image selected in step S103 based on the target image analysis result obtained in step S105.

As abnormal region detection, for example, when a three-dimensional chest CT image is a target image to be analyzed, and if in step S105 it is determined that the target image includes an image of the heart, the CPU 111 performs abnormal detection for the heart. For example, a coronary calcification can be detected as abnormality of the heart by identifying a main artery and a pulmonary artery in a mediastinum region and detecting a small high-density region on a surface of the heart where the coronary spreads.

Further, if it is determined that the same three-dimensional chest CT image includes an image of the lung, the CPU 111 further performs abnormal detection for the lung. In this case, the lung abnormality detection can be performed referring to various information usable for detection and identification of a lung tumor, such as an internal structure of a tumor, peripheral properties, and related forms of any existing structures, such as a lung blood vessel and the bronchi (see, Kawata, Niki, and Ohmatsu, “Curvature Based Internal Structure Analysis of Pulmonary Nodules Using Thoracic 3-D CT Images,”, The transactions of the Institute of Electronics, Information and Communication Engineers, D-II, Vol. J83-D-II, No. 1, pp. 209-218, January 2000).

Next, in step S302, the CPU 111 newly determines the order in the region candidate list generated in step S106 based on the region abnormality information detected in step S301. Then, the CPU 111 rearranges the region candidate list.

For example, if in step S105 it is determined that the target image includes both an image of the heart and an image of the lung, then in step S106, the CPU 111 adds both the heart and the lung in the region candidate list. Further, if in step S301 it is determined that a coronary calcification is detected in the heart, then in step S302, the CPU 111 newly sets the order of the heart to be higher than that of the lung in the region candidate list.

Then, the CPU 111 generates the schema background image candidate list of basic schema image candidates corresponding to the regions again, with reference to the rearranged region candidate list. Therefore, according to the above-described example, the basic schema background image of the heart can be displayed at the upper position when a plurality of schema background image candidates are displayed (see FIG. 5) in the post-processing step S108.

Then, in the present exemplary embodiment, the CPU 111 executes the processing of the above-described steps S107 to S110 illustrated in FIG. 2. Through the above-described processing, as illustrated in FIG. 6, a medical document to which the basic schema background images are added can be displayed (output) in the window 301 of the monitor 120.

Next, in step S303, the CPU 111 performs processing for displaying (outputting) an composite image that includes the region abnormality information detected in step S501 in addition to the schema background image selected and displayed in step S109. In the processing for adding the abnormality information, the CPU 111 determines a size and a shape of the abnormal region relative to the schema background image based on the size of a region extracted from the target image as well as the size and the shape of the abnormal region. Then, the CPU 111 adds the abnormality information to the schema background image based on the position of the abnormal region relative to the target image.

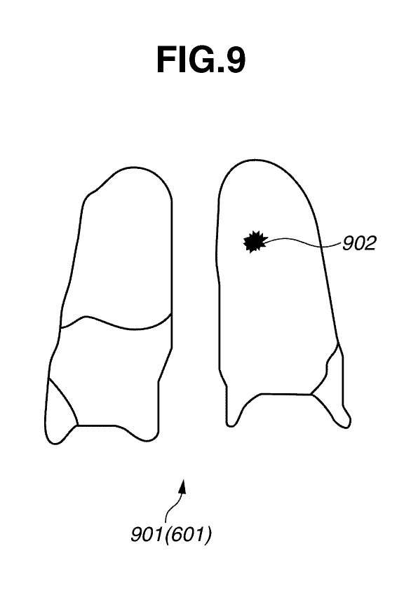

FIG. 9 is a view schematically illustrating an example of a schema background image to which abnormality information is added according to the second exemplary embodiment of the present invention. A basic schema image 901 relating to a lung schema background image illustrated in FIG. 9, which corresponds to the basic schema image 601 illustrated in FIG. 6, includes an illustration indicating a position and a size of a lung tumor 902 (i.e., an abnormal region) added as abnormality information.

After completing the processing in step S303, the CPU 111 terminates the processing of the flowchart illustrated in FIG. 8.

In the present exemplary embodiment, the abnormality information is added (see step S303) after the schema background image to be added to the medical document is selected. However, the order of processing is not limited to the above-described example. For example, the abnormality information can be added beforehand to the schema background image candidate to be displayed (output) on the monitor 120 in step S108 illustrated FIG. 8. Further, it is also useful to indicate abnormality information relating to the plurality of human body regions detected in step S301 to the physician. Thus, each schema background image candidate can be indicated based on the abnormality information selected by the physician.

As described above, the second exemplary embodiment detects the presence of any abnormal region captured in each target image and can select a schema background image including an abnormal region. Therefore, the second exemplary embodiment can efficiently select a suitable schema background image. Further, the second exemplary embodiment can add abnormality information to the selected schema background image, for example, to enable a physician (a user) to easily find an abnormal portion.

A third exemplary embodiment of the present invention is described below. The third exemplary embodiment is different from the first exemplary embodiment or the second exemplary embodiment in part of the processing procedure in steps S105 and 5106 illustrated in FIG. 2 or FIG. 8.

According to the above-described first or second exemplary embodiment, in step S105 the CPU 111 identifies a human body region of a photographed person that is indicated by the selected target image. However, the present invention is not limited to the above-described processing.

For example, to precisely observe a medical image, a physician may adjust a contrast of a target image. The target image may include a region that is easy to observe and a region that is not easy to observe because of the contrast adjustment (display conditions) of the target image. Hence, in the processing to be performed in step S105 according to the third exemplary embodiment, the CPU 111 analyzes the contrast of each target image to identify a region which receives attention in the target image. In this manner, by analyzing the target image which has been subjected to the contrast adjustment, the CPU 111 can identify a region which has a better display contrast as a target region. For example, the CPU 111 divides the contrast adjusted target image into a plurality of segments and analyzes a contrast distribution for each divided segment to determine the target region. Then, the CPU 111 identifies the position of the target region as described above.

Further, in the processing for generating the region candidate list (i.e., in the processing to be performed in step S106) according to the third exemplary embodiment, the CPU 111 arranges the target region which is easy to observe (i.e., if it has a better display contrast) so as to be ranked higher in the list.

According to the third exemplary embodiment, an attribute of each target image is analyzed, so that a specific region in the target image to which the user (i.e., the physician) pays attention can be identified. Therefore, the third exemplary embodiment can prioritize the specific region to which the user pays attention in the display processing so that the user can efficiently select a suitable schema background image from a plurality of schema background images when a medical document is generated.

To realize each step (each functional unit) of the method for controlling the computer-aided diagnosis apparatus 100 according to the above-described exemplary embodiments of the present invention (see FIGS. 2, 7, and 8), the CPU 111 of the computer can execute the program stored in a storage medium (e.g., the main memory 112). The present invention encompasses the above-described programs and the computer-readable storage medium that stores the programs.

Further, the present invention can be embodied, for example, as a system, an apparatus, a method, a program or a storage medium. More specifically, the present invention is applicable to a system including a plurality of devices. Further, the present invention is applicable to an apparatus including only one device.

The present invention encompasses software programs (i.e., programs corresponding to the flowcharts illustrated in FIGS. 2, 7, and 8 in the above-described exemplary embodiments) that can realize the functions of the above-described exemplary embodiments. The software programs according to the present invention can be directly or remotely supplied to a system or an apparatus. The present invention further encompasses a computer of the system or the apparatus when the computer can read and execute the supplied program code.

Accordingly, the present invention encompasses the program code itself installable on a computer when the functions or processes of the exemplary embodiments can be realized by the computer. In other words, the present invention encompasses the computer program itself that can realize the functions and processes of the exemplary embodiments.

In this case, the programs can be replaced with any one of object codes, programs executed by an interpreter, and script data to be supplied to an OS, if their functions are comparable with the programs.

A storage medium supplying the programs can be selected from any one of a floppy disk, a hard disk, an optical disk, a magneto-optical (MO) disk, a compact disk-ROM (CD-ROM), a CD-recordable (CD-R), a CD-rewritable (CD-RW), a magnetic tape, a nonvolatile memory card, a ROM, and a DVD (DVD-ROM, DVD-R).

A method for supplying the programs includes accessing a web site on the Internet using a browser of a client computer, when the web site allows each user to download the computer programs relating to the present invention, or compressed files of the programs including automatic installing functions, to a hard disk or other recording medium of the user.

Furthermore, the program code constituting the programs relating to the present invention can be divided into a plurality of files so that respective files are downloadable from different web sites. Thus, the present invention encompasses World Wide Web (WWW) servers that allow numerous users to download the program files so that the functions and processes of the present invention can be realized on their computers.

Encrypting the programs relating to the present invention and storing the encrypted programs on a CD-ROM or comparable recording medium is an exemplary method when the programs relating to the present invention are distributed to the users. The authorized users who satisfy predetermined conditions are allowed to download key information from a web site on the Internet. The users can decrypt the programs with the obtained key information and can install the programs on their computers.

When the computer reads and executes the installed programs, the functions of the above-described exemplary embodiments can be realized. Moreover, an operating system (OS) or other application software running on a computer can execute a part or all of actual processing based on instructions of the programs, to realize the functions of the above-described exemplary embodiments.

Additionally, the programs read out from a storage medium can be written into a memory of a function expansion board inserted in a computer or into a memory of a function expansion unit connected to the computer. In this case, based on instructions of the program, a CPU provided on the function expansion board or the function expansion unit can execute a part or all of the actual processing so that the functions of the above-described exemplary embodiments can be realized.

The above-described exemplary embodiments are mere examples that can embody the present invention. Therefore, it is to be understood that the scope of the present invention cannot be narrowly interpreted. The present invention can be embodied in various ways without departing from the technical concept thereof or essential features thereof.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-015786 filed Jan. 22, 2009, which is hereby incorporated by reference herein in its entirety.

1. A computer-aided diagnosis apparatus that includes a storage unit configured to store a plurality of schema background images and can support a diagnosis to be performed based on at least one of the schema background images, the computer-aided diagnosis apparatus comprising:
an input unit configured to input medical inspection data of an inspection object;
an analysis unit configured to analyze the medical inspection data;
a selection unit configured to select a schema background image from the plurality of schema background images stored in the storage unit based on an analysis result obtained by the analysis unit; and
an output unit configured to output the schema background image selected by the selection unit.

2. The computer-aided diagnosis apparatus according to claim 1, wherein the selection unit is configured to generate a schema background image candidate list based on the analysis result obtained by the analysis unit and select the schema background image based on the generated list.

3. The computer-aided diagnosis apparatus according to claim 1, wherein the analysis unit is configured to analyze whether the medical inspection data includes an abnormal candidate.

4. The computer-aided diagnosis apparatus according to claim 1, wherein the analysis unit is configured to extract a region included in the medical inspection data and analyze whether an abnormal candidate is present in the extracted region.

5. The computer-aided diagnosis apparatus according to claim 3, wherein in a case where the abnormal candidate is included in the analysis result obtained by the analysis unit, the output unit is configured to add abnormality information relating to the abnormal candidate to the schema background image selected by the selection unit.

6. The computer-aided diagnosis apparatus according to claim 1, wherein the medical inspection data is medical image data.

7. The computer-aided diagnosis apparatus according to claim 1, wherein the storage unit is configured to store a plurality of schema background images for a same region of a human body, and wherein each of the plurality of background images includes a different degree of detail.

8. A computer-aided diagnosis system comprising:
a computer-aided diagnosis apparatus according to claim 1;
a medical image database configured to store medical image data that can be used as medical inspection data; and
a medical document database configured to store medical document data to which the schema background image selected by the selection unit can be added,
wherein the computer-aided diagnosis apparatus is connected to the medical image database and the medical document database via a network.

9. A method for supporting diagnosis with a computer-aided diagnosis apparatus, the apparatus including a storage unit configured to store a plurality of schema background images, the method comprising:
inputting medical inspection data of an inspection object;
analyzing the medical inspection data so as to obtain an analysis result;
selecting a schema background image from the plurality of schema background images stored in the storage unit based on the analysis result obtained by the analyzing step; and
outputting the selected schema background image.

10. A computer-readable storage medium storing thereon a computer-executable program for causing a computer to control each unit of a computer-aided diagnosis apparatus according to claim 1.

11. The computer-readable storage medium according to claim 10 further storing thereon instructions for causing the computer-aided diagnosis apparatus to connect to:
a medical image database configured to store medical image data that can be used as the medical inspection data; and
a medical document database configured to store medical document data to which the schema background image selected by the selection unit can be added,
wherein the computer-aided diagnosis apparatus is connected to the medical image database and the medical document database via a network.
